(19) United States
(12) Patent Application Publication
(10) Pub. No.: US 2015/0140349 A1
(43) Pub. Date: May 21, 2015

(54) DISPLAY DEVICE INCLUDING GEL MATERIAL COATING LAYER, AND MANUFACTURING AND REPAIR METHODS OF THE SAME

(71) Applicant: Samsung Display Co., Ltd., Yongin-City (KR)

(72) Inventors: EUNJUNG LEE, Seongnam-si (KR); SEUNGBAE LEE, Seoul (KR); JONGHO CHONG, Hwaseong-si (KR)

(21) Appl. No.: 14/303,990

(22) Filed: Jun. 13, 2014

(30) Foreign Application Priority Data
Nov. 18, 2013 (KR) 10-2013-0140137

(51) Int. Cl. C09D 189/00; C09D 105/12

(52) U.S. Cl. CPC C09D 189/00; C09D 105/12
USPC 428/478.2; 156/280; 427/140; 427/532; 427/553; 427/554; 428/532

(57) ABSTRACT

A display device comprises a display panel, a window layer and a coating formed of gel material. The window layer is formed on the display panel and the coating layer is formed on the window layer.

This application claims priority to Korean Patent Application No. 10 -2013-0140137, filed on Nov. 18, 2013, and all the benefits accruing therefrom under 35 U.S.C. §119, the entire contents of which are hereby incorporated by reference.

### BACKGROUND

(1) Field

The invention relates to a display device including a coating layer including a gel material, and manufacturing and repair methods of the display device. More particularly, the invention relates to a display device including a restorable coating layer including a gel material, and manufacturing and repair methods of the display device.

(2) Description of the Related Art

In a liquid crystal display (“LCD”), a liquid crystal is injected between two LCD panels such as glass plates of an LCD panel of the LCD. If an electrical pressure such as an electrical field is applied to the liquid crystal, an arrangement of a liquid crystal molecule of the liquid crystal is changed and various charters and images are displayed on the LCD panel by a change of an optical refractive index caused by the change of the arrangement of the liquid crystal molecule. Since the LCD operates at a power supply voltage of about 1.5 volts (V) to about 2 V and has relatively low power consumption, the LCD is widely used in various electronic devices such as a cellular phone, a personal digital assistant (“PDA”), a MP3 device, a computer monitor, a television, etc.

### SUMMARY

A window of a liquid crystal display (“LCD”) is a transparent protective window installed on an external surface of a LCD panel of the LCD, to protect the LCD panel from an external impact. As a digital industry develops, digital electronic devices are miniaturized and become relatively slim, such that thicknesses of the LCD panel and the window are decreased.

A window is protected by including a protective layer such as a hard coating layer on a base structure of the window. The hard coating layer has a problem in that a surface thereof may be easily scratched by an external impact or a contact thereto.

One or more exemplary embodiment of the invention provides a display device including a protective window with improved impact resistance.

An exemplary embodiment of the invention provides a display device including a display panel; a coating layer on the display panel and including a gel material; and a window layer between the display panel and the coating layer.

An exemplary embodiment of the invention also provides a manufacturing method of a display device. The manufacturing method includes forming a window layer on a display panel; and forming a coating layer including gel material, on the window layer.

An exemplary embodiment of the invention also provides a repair method of a display device. The repair method includes preparing a display device including a coating layer which includes gel material, and a defect; liquefying the coating layer; and hardening the liquefied coating layer.

### BRIEF DESCRIPTION OF THE FIGURES

The above and other advantages and features of this disclosure will become more apparent by describing in further detail exemplary embodiments thereof with reference to the accompanying drawings, in which:

FIG. 1 is a cross sectional view illustrating an exemplary embodiment of a display device in accordance with the invention.

FIG. 2 is a flow chart illustrating an exemplary embodiment of a manufacturing method of a display device in accordance with the invention.

FIGS. 3 and 4 are cross sectional views sequentially illustrating the manufacturing method of a display device in accordance with the invention.

FIG. 5 is a flow chart illustrating an exemplary embodiment of a repair method of a display device in accordance with the invention.

### DETAILED DESCRIPTION

Exemplary embodiments of the invention will be described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will also be understood that when an element such as a layer, region or substrate is referred to as being “on” or “onto” another element, it may lie directly on the other element or intervening elements or layers may also be present. As used herein, the term “and/or” includes any and all combinations of one or more of the associated listed items.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be described in detail with reference to the accompanying drawings.

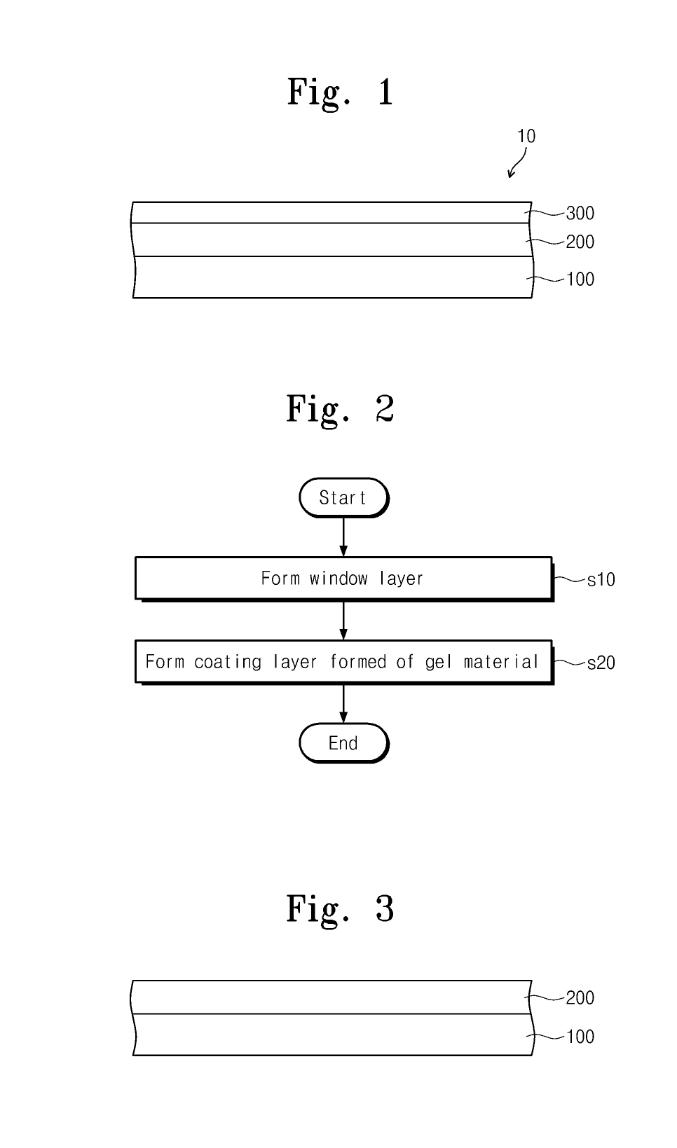

FIG. 1 is a cross sectional view illustrating an exemplary embodiment of a display device in accordance with the invention.

A display device 10 includes a display panel 100 which displays an image, a window layer 200, and a coating layer 300 including of gel material. The window layer 200 is disposed on the display panel 100. The coating layer 300 is disposed on the window layer 200.

The display panel 100 may be one of various types of display panels such as an organic light emitting display (“OLED”) panel, a liquid crystal display (“LCD”) panel, a plasma display panel, an electrophoretic display panel and an electrowetting display panel.

The window layer 200 may include a glass substrate or a synthetic resin material substrate such as including poly carbonate, polyethylene terephthalate, etc. The window layer 200 may be transparent or translucent and configured to transmit display light of the display panel 100 toward outside the display device 10.

The coating layer 300 is defined as a coating layer which is solidified in a gel form at a room temperature. The display device 10 includes the coating layer 300 including gel material instead of a conventional hard coating layer on the window layer 200. Where a defect such as a scratch, crack, etc. occurs on the coating layer 300 including the gel material, by an external impact or contact to the coating layer 300, the defect such as the scratch, crack, etc. can be easily removed by applying heat to the coating layer 300. That is, the coating layer 300 having defects can be easily restored to a state of the coating layer 300 before defects occur and/or a state of the coating layer 300 absent of defects.

Like the window layer 200, the coating layer 300 may also be transparent or translucent and configured to transmit display light of the display panel 100 toward outside the display device 10.

The coating layer 300 may include gelatin, agarose polymer, etc.

The coating layer 300 including gel material may have viscosity of about 10¹² to about 10⁴⁰ pascal-seconds (Pa·s). Where the viscosity of the coating layer 300 is lower than 10¹² Pa·s, solidifying the coating layer 300 in a gel form at a room temperature may be difficult. Where the viscosity of the coating layer 300 is higher than 10⁴⁰ Pa·s, forming a coating layer may be difficult.

The display device 10 may further include a polarizing plate (not shown), an adhesion layer (not shown) and/or a touch screen (not shown) disposed on the display panel 100, or disposed in the display panel 100.

The display panel 100 and the window layer 200 may be flexible. That is, the coating layer 300 may be included in a flexible display device.

FIG. 2 is a flow chart illustrating an exemplary embodiment of a manufacturing method of a display device in accordance with the invention.

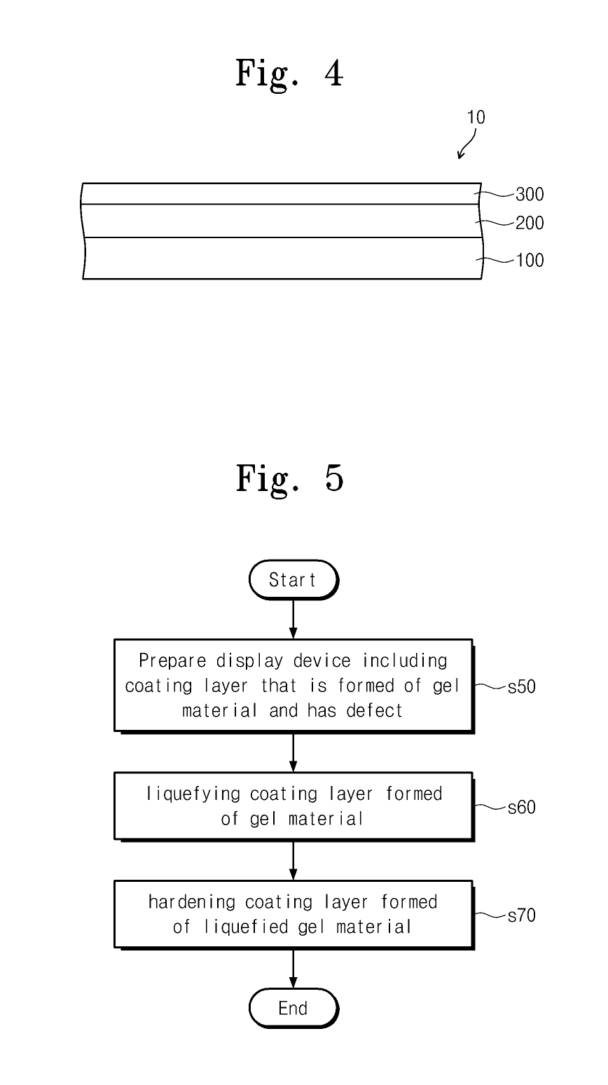

FIGS. 3 and 4 are cross sectional views sequentially illustrating the manufacturing method of a display device in accordance with the invention.

Referring to FIG. 2, the manufacturing method of the display device may include forming a window layer on a display panel (s10) and forming a coating layer including gel material on the window layer (s20).

Referring to FIGS. 2 and 3, a window layer 200 is formed (e.g., provided) on a display panel 100 or other element which will be protected by the window layer 200. The display panel 100 may include various types of display panels such as an OLED panel, a LCD panel, a plasma display panel, an electrophoretic display panel and an electrowetting display panel. The window layer 200 may include a glass substrate, or a synthetic resin substrate such as including poly carbonate, polyethylene terephthalate, etc.

Referring to FIGS. 2 and 4, a coating layer 300 including gel material is formed on the window layer 200 (s20). The manufacturing method of the display device forms the coating layer 300 including the gel material instead of a conventional hard coating layer on the window layer 200. Where a defect such as scratch, crack, etc. occurs on the coating layer 300 including the gel material, by an external impact or contact applied thereto, the defect such as scratch, crack, etc. can be easily removed by applying heat to the coating layer 300. That is, the coating layer 300 having defects can be easily restored to a state of the coating layer 300 before defects occur and/or a state of the coating layer 300 absent of defects.

The coating layer 300 including the gel material may include gelatin, agarose polymer, etc.

The display device 10 may be flexible. The coating layer 300 may be included in the flexible display device 10 and may itself be flexible.

FIG. 5 is a flow chart illustrating an exemplary embodiment of a repair method of a display device in accordance with the invention.

Referring to FIG. 5, a repair method of a display device includes preparing a display device including a coating layer which includes gel material and has a defect (s50), liquefying the coating layer (s60), and hardening the liquefied coating layer (s70).

Referring to FIG. 5, a display device including a coating layer which includes gel material and has a defect is prepared (s50). Since the coating layer is disposed on the outermost surface of the display device, a defect such as scratch, crack, etc. easily occurs on the coating layer due to an external impact or contact thereto. In a conventional display device, since a hard coating layer is used on a window layer, if a defect such as scratch, crack, etc. occurs on the hard coating layer, the defect cannot be easily removed. In one or more exemplary embodiment in accordance with the invention, in a coating layer formed of gel material, a defect such as scratch, crack, etc. in the coating layer can be easily removed by applying heat to the defective or damaged coating layer. That is, the coating layer can be easily restored to a state of the coating layer before a defect occurs and/or a state of the coating layer absent of defects.

Referring to FIG. 5, the coating layer which is formed of gel material and has a defect such as scratch, crack, etc. due to an external impact or contact, is liquefied (s60). In an exemplary embodiment, the coating layer which is formed of gel material, is liquefied when it is on the display panel and the window layer of the display device. In liquefying the coating layer, scratch, crack, etc. are removed. The liquefying the coating layer (s60) can be performed by applying heat and/or light to the defective or damaged coating layer so that the coating layer has a temperature of about 80 degrees Celsius (° C.) to about 200° C. Where the temperature is less than 80° C. , due to a low temperature of less than 80° C., liquefy the coating layer formed of gel material and has a defect such as scratch, crack, etc. may be difficult. Where the temperature is higher than 200° C., the coating layer as liquefied gel material may be evaporated such that a window layer, a display panel, etc. upon which the coating layer is disposed may be damaged due to a high temperature higher than 200° C.

The liquefying the coating layer (s60) can be performed by irradiating light using one or more irradiators selected from an ultraviolet irradiator, an infrared irradiator and a laser irradiator. The coating layer can be liquefied by irradiating ultraviolet light, infrared light and laser light into the coating layer through the ultraviolet irradiator, the infrared irradiator and the laser irradiator, respectively, and thereby a defect such as scratch, crack, etc. in the coating layer can be removed.

Referring to FIG. 5, the liquefied coating layer is hardened (s70). The liquefied coating layer can be solidified in a gel form at a temperature room by hardening the liquefied coating layer. In an exemplary embodiment, the liquefied coating layer which is formed of gel material, is hardened when it is on the display panel and the window layer of the display device.

The coating layer can be formed by coating gelatin, agarose polymer, etc.

The hardening the coating layer (s70) can be performed by applying heat and/or light to the liquefied coating layer so that the coating layer has a temperature of about 20° C. to about 50° C. Where the temperature is lower than 20° C., a hardening speed of the coating layer is relatively low due to a low temperature lower than 20° C. Where the temperature is higher than 50° C., hardening the coating layer due to a high temperature higher than 50° C. may be difficult.

The hardening the coating layer (s70) can be performed by irradiating light using one or more hardeners selected from an ultraviolet hardener, an infrared hardener and a laser hardener. The liquefied coating layer can be hardened by irradiating ultraviolet light, infrared light and laser light into the liquefied coating layer through the ultraviolet irradiator, the infrared irradiator and the laser irradiator, respectively, and thereby a defect such as scratch, crack, etc. occurred in the coating layer can be removed.

One or more element of the display device may be flexible to define a flexible display device. The coating layer may be included in a flexible display device.

According to one or more exemplary embodiment of a display device in accordance with the invention, a display device includes a gel material coating layer which is restorable to a pre-defect or defect-free state.

According to one or more exemplary embodiment of a manufacturing method of a display device in accordance with the invention, a display device including a gel material coating layer which is configured to be restored to a pre-defect or defect-free state, can be manufactured.

According to one or more exemplary embodiment of a repair method of a display device in accordance with the invention, the display device including a gel material coating layer which is restorable to a pre-defect or defect-free state, may be repaired.

Although a few exemplary embodiments of the invention have been shown and described, it will be appreciated by those skilled in the art that changes may be made in these exemplary embodiments without departing from the principles and spirit of the invention, the scope of which is defined in the appended claims and their equivalents. Therefore, the above-disclosed subject matter is to be considered illustrative, and not restrictive.

What is claimed is:

1. A display device comprising:
a display panel;
a coating layer on the display panel and comprising a gel material; and
a window layer between the display panel and the coating layer.

2. The display device of claim 1, wherein the coating layer is transparent or translucent.

3. The display device of claim 1, wherein the coating layer comprises gelatin.

4. The display device of claim 1, wherein the coating layer comprises agarose polymer.

5. The display device of claim 1, wherein the coating layer has viscosity of about 10¹² pascal-seconds to about 10⁴⁰ pascal-seconds.

6. The display device of claim 1, further comprising a polarizing plate, an adhesion layer or a touch screen on the display panel.

7. The display device of claim 1, wherein a portion of the display panel is flexible.

8. The display device of claim 1, wherein the window layer is flexible.

9. A manufacturing method of a display device, comprising:
forming a window layer on a display panel; and
forming a coating layer comprising gel material, on the window layer.

10. The manufacturing method of a display device of claim 9, wherein the coating layer is formed by coating gelatin.

11. The manufacturing method of a display device of claim 9, wherein the coating layer is formed by coating agarose polymer.

12. The manufacturing method of a display device of claim 9, wherein a portion of the display panel is flexible.

13. A repair method of a display device, comprising:
preparing a display device comprising a coating layer and a defect;
liquefying the coating layer; and
hardening the liquefied coating layer.

14. The repair method of a display device of claim 13, wherein the coating layer is formed by coating gelatin.

15. The repair method of a display device of claim 13, wherein the coating layer is formed by coating agarose polymer.

16. The repair method of a display device of claim 13, wherein the liquefying the coating layer is performed by applying heat or light to the coating layer so that the coating layer has a temperature of about 80 degrees Celsius to about 200 degrees Celsius.

17. The repair method of a display device of claim 13, wherein the liquefying the coating layer is performed by irradiating light using one or more irradiators selected from an ultraviolet irradiator, an infrared irradiator and a laser irradiator.

18. The repair method of a display device of claim 13, wherein the hardening the liquefied coating layer is performed by applying heat or light to the liquefied coating layer so that the coating layer has a temperature of about 20 degrees Celsius to about 50 degrees Celsius.

19. The repair method of a display device of claim 13, wherein the hardening the liquefied coating layer is performed by irradiating light using one or more hardeners selected from an ultraviolet hardener, an infrared hardener and a laser hardener.

20. The repair method of a display device of claim 13, wherein a portion of the display device is flexible.
